(19) United States
(12) Patent Application Publication
(10) Pub. No.: US 2002/0012347 A1
(43) Pub. Date: Jan. 31, 2002

(54) System and method for downloading code

(76) Inventor: Patrick Fitzpatrick, San Diego, CA (US)

Correspondence Address: Merle W. Richman III, PO Box 3333, La Jolla, CA, 92038-3333, US

(21) Appl. No.: 09/835,301

(22) Filed: Apr. 13, 2001

Related U.S. Application Data
(60) Provisional application No. 60/197,312, filed on Apr. 14, 2000.
(60) Provisional application No. 60/197,297, filed on Apr. 14, 2000.
(60) Provisional application No. 60/197,848, filed on Apr. 14, 2000.
(60) Provisional application No. 60/197,308, filed on Apr. 14, 2000.
(60) Provisional application No. 60/197,233, filed on Apr. 14, 2000.
(60) Provisional application No. 60/182,822, filed on Feb. 16, 2000.
(60) Provisional application No. 60/180,085, filed on Feb. 3, 2000.
(60) Provisional application No. 60/197,234, filed on Apr. 14, 2000.
(60) Provisional application No. 60/197,320, filed on Apr. 14, 2000.

(51) Int. Cl. H04L 12/28

(52) U.S. Cl. 370/392; 370/431

(57) ABSTRACT

A system and method for downloading code or other data to a group of remote units via a plurality of data paths. The data paths used for transmission may be selected based on the criticality of the code or data to the remote unit and the loss rate potential of each data path. The system and method may download the data using a carouselling technique.

### CROSS REFERENCE TO RELATED APPLICATIONS

This invention is related to Utility patent application Ser. No. 09/775,692, filed Feb. 2, 2001, Attorney Docket No. 50N3463.01, and entitled “Web Browser Plug-in for TV”, Provisional Patent Application No. 60/197,312, filed Apr. 14, 2000, Attorney Docket No. 50P3987, and entitled “Method for Downloading Code”, Provisional Patent Application No. 60/197,297, filed Apr. 14, 2000, Attorney Docket No. 50P3986, and entitled “Contextual Web Page”, Provisional Patent Application No. 60/197,848, filed Apr. 14, 2000, Attorney Docket No. 50P3988, and entitled “User Interface for a Set-Top Box”, Provisional Patent Application No. 60/197,308, filed Apr. 14, 2000, Attorney Docket No. 50P3984, and entitled “Method for VOD”, Provisional Patent Application No. 60/197,233, filed Apr. 14, 2000, Attorney Docket No. 50P3877, and entitled “Cable Modem Set Top Box”, Provisional Patent Application No. 60/182,822, filed Feb. 16, 2000, Attorney Docket No. 50N3464, and entitled “Support for Television Viewing in a Standard Web Browser”, Provisional Patent Application No. 60/180,085, filed Feb. 3, 2000, Attorney Docket No. 50N3463, and entitled “Web Browser Plug-in for TV”, Provisional Patent Application No. 60/197,234, filed Apr. 14, 2000, Attorney Docket No. 50P3985, and entitled “Web Based EPG Support”, Provisional Patent Application No. 60/197,320, filed Apr. 14, 2000, Attorney Docket No. 50P3983, and entitled “Support for tuning while viewing a Web Based EPG”, and Provisional Patent Application filed Jan. 30, 2001, Attorney Docket Number SNY001V, and entitled “Web Browser and Set Top Box Interface System and Method”, each of which is hereby incorporated by reference for their teachings.

### BACKGROUND OF THE INVENTION

1. Field of the Invention

This invention relates to downloading code to a remote device, and more particularly to downloading code to a plurality of remote devices.

2. Description of Related Art

Many remotely programmable/updateable systems exists, including set top boxes (“STB”s) coupled to cable systems, STBs coupled to satellite systems, meter reading systems coupled to power systems and others. These systems may employ millions of remote units that may include software. Due to the release of updates to (such as new functionality) or corrections of existing software, it may be necessary to transmit code to millions of units. In addition, units may have different hardware or software versions depending on their configuration when placed on a network.

For example, in a cable network of set top boxes, upgrade client/server software on one or more cable system's head ends may be responsible for handling the remote upgrading of Set Top Box (STB) software. The initial releases of STB's may contain limited functionality. When functionality is added or patches are released, remote upgrading via the Upgrade Server should enable hands-off, trouble free upgrading of the set top box software. As noted, the number of set top boxes in a cable system may reach millions. Accordingly, the Upgrade process must be efficient and scalable. In addition, the Upgrade process cannot introduce any error or failure during an upgrade that renders a box unusable, which then may require on-site service or return to the manufacturer. Given these requirements, the Upgrade process/system must be efficient, scalable, failsafe, secure, user friendly and reliable.

### SUMMARY OF THE INVENTION

The present invention includes an apparatus and a method of downloading code to at least one remote unit on a network having a plurality of remote units. For each remote unit there is a plurality of data paths for transmitting code. The invention selects one of the plurality of data paths based on the code to be transmitted to the at least one unit and transmits the code to the at least one remote unit on the selected data path. It is noted that the units may be set top boxes. Further, the code may be software code used to update the software running on the at least one unit.

In one embodiment, at least one path of the plurality of paths has a different data rate loss than the other paths of the plurality of data paths. Further, the invention then selects one of the plurality of data paths based on the code to be transmitted and the data rate loss of the path. The invention may also select one of the plurality of data paths having the lowest data rate loss. Additionally, the invention may select one of the plurality of data paths having the lowest data rate loss when the code represents critical software for the at least one unit. Similarly, the invention may select one of the plurality of data paths having the lowest data rate loss where the code represents critical software stored in non-erasable memory of the at least one unit.

In another embodiment, the invention may transmit the code to the plurality of remote units in a descriptor file that indicates the at least one remote unit is recipient of the code. Further, the invention may transmit a descriptor file to the plurality of units that indicates at least one remote unit is to receive the code; and transmit the code to all remote units. Additionally, the invention may separate the code into a plurality of modules. Then invention may then transmit a descriptor file to the plurality of units that indicates at least one remote unit is to receive the code and the code is separated into a plurality of modules and transmit the plurality of modules to the plurality of remote units.

In a further embodiment, the invention may include each remote unit receiving the descriptor file and each remote unit retrieving the modules identified by the descriptor file when the descriptor file indicates the remote unit is to receive the modules. Additionally, the invention may include each remote unit receiving the descriptor file and each remote unit retrieving the modules identified by the descriptor file and assembling the modules into the code when the descriptor file indicates the remote unit is to receive the modules. Similarly, the invention may include each remote unit receiving the descriptor file and each remote unit retrieving the modules identified by the descriptor file, assembling the modules into the code, and installing the code when the descriptor file indicates the remote unit is to receive the modules.

### BRIEF DESCRIPTION OF THE DRAWINGS

FIG. 1 is a block diagram digital cable television system in accordance with the present invention.

FIG. 2 is a block diagram of the set top box shown in FIG. 1.

FIG. 3 is a block diagram of a set top box according to an embodiment of the present invention.

FIG. 4 is a detailed block diagram of the set top box of FIG. 3.

FIG. 5 is a block diagram of the software architecture of the set top box of FIG. 4.

FIG. 6 is a block diagram of cable architecture in accordance with the present invention.

FIG. 7 is a block diagram of the cable architecture shown in FIG. 6 detailing a data-downloading embodiment in accordance with the present invention.

FIG. 8 is illustration of one embodiment of a data carouselling technique in accordance with the present invention.

FIG. 9 is a flowchart of a process of transmitting an upgrade to a group of STBs using data carousels in accordance with the present invention.

FIG. 10 is a flowchart of a process of retrieving an upgrade within an STB using data carousels in accordance with the present invention.

Like reference numbers and designations in the various drawings indicate like elements.

### DETAILED DESCRIPTION OF THE PREFERRED EMBODIMENTS

Throughout this description, the preferred embodiment and examples shown should be considered as exemplars, rather than as limitations on the present invention.

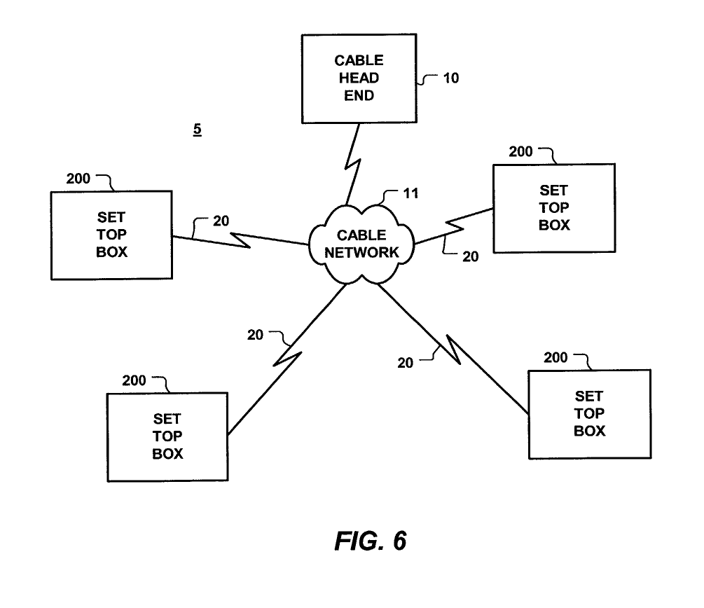

FIG. 6 is a block diagram of exemplary cable architecture 5 in which the present invention may be employed. The architecture 5 includes a cable head end 10, group of set top boxes (“STB”s) 200 coupled to the cable head 10 via cables 200 and a cable network 11. The architecture 5 may include more than one head end 10 placed at various locations throughout the cable network 11. The cable network 11 is series of routers and other connectors enabling communication between one or more cable head ends 10 and the STBs 200. In an exemplary embodiment, there are more than communication channels available between the STBs and the cable head end. In particular, there may be three channels including, a cable modem interface channel, out of band channel, and in band data channel.

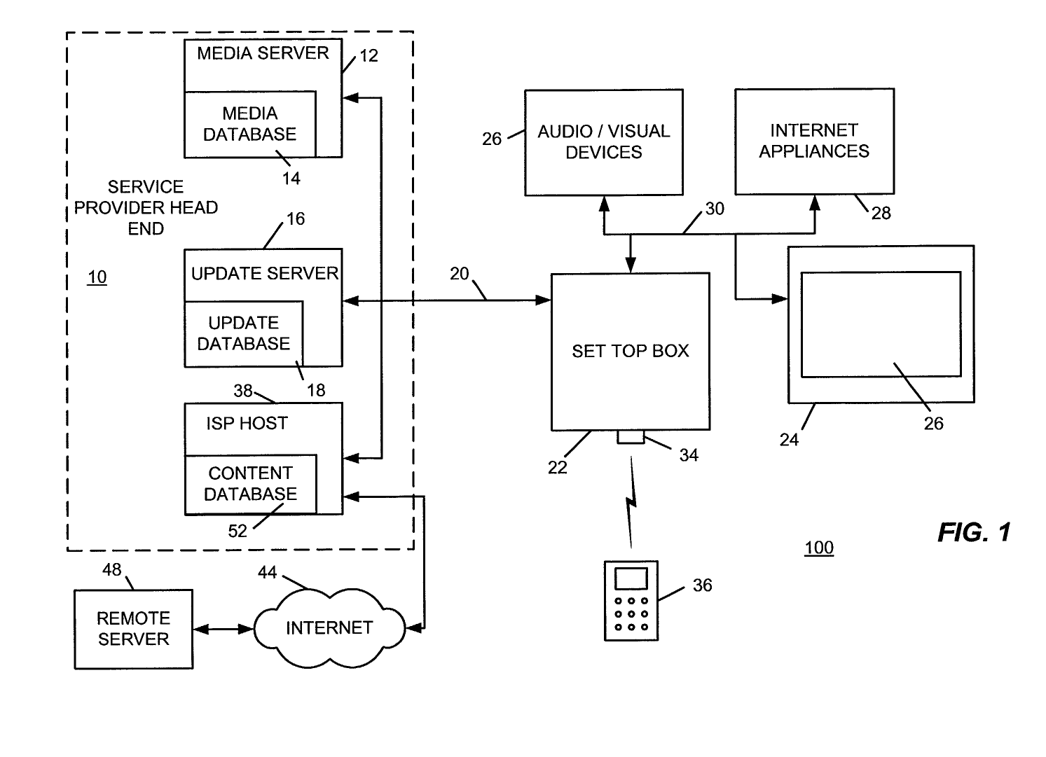

One exemplary cable architecture 100 is shown in FIG. 1 FIG. 1 is a block diagram for an exemplary interactive cable or satellite television (TV) architecture or system 100 in which the present invention may be employed. The system 100 includes a service provider head end 10, remote server 48, Internet 44, audio/visual devices 26, Internet appliances 28, television 24, set-top box (“STB”) 22, and remote control 36. The head end of the service provider 10 includes a media server 12, software code update server 16, and ISP Host 38. The media server 12 of the head end 10 provides on demand movies and other programming such as interviews with actors, games, advertisements, available merchandise, associated Web pages, and other related content obtained from a media database 14. The software code update server 16 includes a software code update database 18 for generating update modules to be transmitted to STBs. The ISP host 38 includes a content database 52 and is coupled to remote servers 48 via the Internet 44. The remote servers may include another content such as video on demand (“VOD”) content The ISP host 38 includes protocols that enable communication between remove servers 48 via the Internet 44.

The media server 12 and Software code update server 16 are coupled by a transmission medium 20 to the set top box (STB) 22. The transmission medium 20 (link 525 in FIG. 10) may include, for example, a conventional coaxial cable television network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a coaxial cable television network, transmission medium 20 is commonly realized at the subscriber's premises as a coaxial cable that is connected to a suitable cable connector at the rear panel of the STB 22. The STB 22 represents the media generation system 200 shown in FIG. 10.

As noted, system 100 further includes a TV 24, such as a digital television. The TV 24 includes a display 26 for displaying programming, a web browser and other content. The STB 22 may be coupled to the TV 24 and various other audio/visual devices 26 and Internet Appliances 28 by an appropriate interface 30 which can be any suitable analog or digital interface including an Institute of Electrical and Electronics Engineers (IEEE) 1394 standard interface, S-Video, Component Video, NTSC, PAL, or other analog television interface.

Set-top box 22 can generally provide for bi-directional communication over a transmission medium 20 in the case of a cable STB 22. In other embodiments, bi-directional communication can be effected using asymmetrical communication techniques possibly using dual communication media, one for the uplink and one for the downlink. In any event, the STB 22 can have its own Universal Resource Locator (URL) assigned thereto to provide for direct addressing by the head end and users of the Internet. In the case of a Direct Satellite System (DSS), the STB 22 is often referred to as an Integrated Receiver Decoder (IRD). The transmission medium is a satellite transmission at an appropriate microwave band. A satellite dish antenna with an integral Low Noise Block (LNB) is used to receive such transmissions. A down-converter converts the received signal to a lower frequency (baseband frequency) for processing by the STB 22.

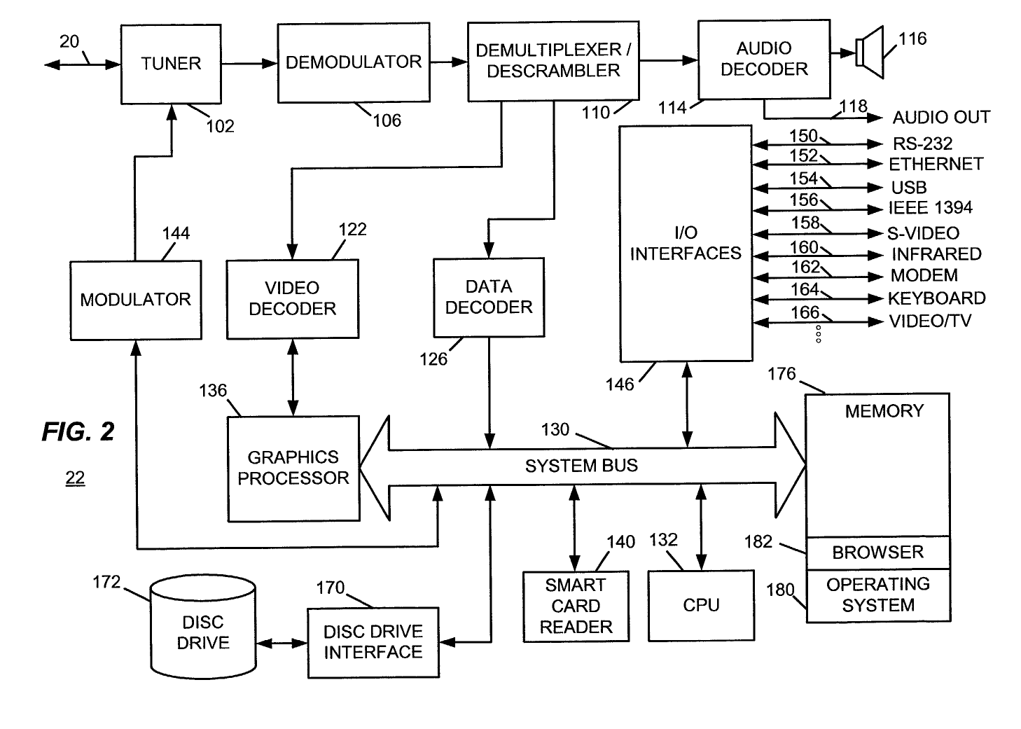

As shown in FIG. 2, the STB 22 may include a central processing unit (CPU) 132 and memory such as Random Access Memory (RAM) 176, Read Only Memory (ROM), flash memory, mass storage such as a hard disc drive 172, floppy disc drive, optical disc drive or may accommodate other electronic storage media. Such memory and storage media is suitable for storing data as well as program instructions for processes to be executed by the CPU. Information and programs stored on the electronic storage media or memory may also be transported over any suitable transmission medium such as that illustrated as 20. STB 22 may include circuitry suitable for audio decoding and processing 114, the decoding of video data 122 compressed in accordance with a compression standard such as the Motion Pictures Experts Group (MPEG) standard and other processing. It is noted that these components may be incorporated into the TV 24, eliminating the STB 22. In addition, a computer may substitute the TV 24 and STB 22. The computer may include a vary of devices capable of generating video media including a tuner card coupled to a digital network, cable television network, or DSS network.

It is noted that the STB 22 may be coupled to additional devices such as a personal computer, video cassette recorder, camcorder, digital camera, personal digital assistant and other audio/visual or Internet related devices (not shown). In addition, a data transport architecture, such as that set forth by an industry group which includes Sony Corporation and known as the Home Audio-Video Interoperability (“HAVi”) architecture may be utilized to enable interoperability among devices on a network regardless of the manufacturer of the device. This architecture may be used to create a home network system between electronic devices and Internet appliances. The STB 22 may run an operating system suitable for a home network system such as Sony Corporation's Aperios™ real time operating system. Other operating systems could also be used.

As shown in FIG. 1, the STB 22 includes an infrared (IR) receiver 34 for receiving IR signals from an input device such as the remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard, or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

One configuration of a digital STB 22 is shown in detail in FIG. 2. The STB 22 includes a tuner 102, demodulator 106, demultiplexer/descrambler 110, audio decoder 114, modulator 144, video decoder 122, data decoder 126, I/O interfaces 146, system bus 130, graphics processor 136, memory 176, central processing unit (“CPU”) 132, smart card reader 140, disc drive interface 170, and disc drive 172. A transmission medium 20, such as a coaxial cable, is coupled by a suitable interface to the tuner 102. Tuner 102 may include a broadcast in-band tuner for receiving content, an out-of-band (“OOB”) tuner for receiving data transmissions and a return path tuner for providing an OOB return path for outbound data (destined for example for the head end). A separate tuner (not shown) may be provided to receive conventional RF broadcast television channels. Demodulator 106 may demodulate any modulated information from the tuner 102 such MPEG-2 formatted data. The demultiplexer/descrambler circuit 110 separates the demodulated information into discrete channels of programming. The programming is divided into packets, each packet bearing an identifier called a Packet ID (PID) that identifies the packet as containing a particular type of data (e.g. audio, video, and data). The demultiplexer/descrambler circuit 110 also decrypts encrypted information in accordance with a decryption algorithm to prevent unauthorized access to programming content, for example.

Audio packets from the circuit 110 (those identified with an audio PID) are decrypted and forwarded to an audio decoder 114. The audio decoder 114 may be convert the audio packets to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the circuit 110 (those identified with a video PID) are decrypted and forwarded to the video decoder 122. Similarly, data packets from the circuit 110 (those identified with a data PID) are decrypted and forwarded to the data decoder 126.

The data decoder 126 transmits decoded data packets to the CPU 132 via the system bus 130. Video decoder 122 passes video data to the graphics processor 136. The graphics processor is a computer optimized to processes graphics information rapidly, in particular graphics intensive data associated with Internet browsing, gaming, and multimedia applications such as those associated with MHEG (Multimedia and Hypermedia information coding Experts Group) set-top box applications. Graphics processor 136 is also coupled to the system bus 130 and operates under the control of CPU 132. It should be noted that the function of a graphics processor 136 may be unnecessary in set-top box designs having lower capabilities. Also the CPU 132 may function as a graphics processor in some applications.

The STB may include a smart card reader 140 for communicating with a so called “smart card”, where the smart card reader 140 acts as a Conditional Access Module (CAM). In CAM systems the smart card reader may include a central processor unit (CPU) with associated RAM and ROM memory. Such smart card based CAMs are conventionally utilized for authentication of the user, of transactions carried out by the user, and of services and storage of cryptography keys. For example, the CAM may be used to provide the key for decoding incoming cryptographic data. STB 22 may operate in a bi-directional communication mode. Accordingly, data and other information may be transmitted from the head end 10 to the STB 22 and from the STB 22 using an out-of-band channel. In one embodiment, the data passes through the system bus 130, modulator 144, and the tuner 102 (operating as a return path OOB tuner) to the transmission medium 20. This enables the STB 22 user to send information to the head end 10, e.g., service requests, software updates, or changes and registration information.

Set-top box 22 may include any of a plurality of I/O (Input/Output) signals at I/O interface 146 for interconnection with other devices. By way of example, and not limitation, a serial RS-232 signal may be provided at port 150 to enable interconnection to any suitable serial device supported by the STB 22's internal software. Similarly, communication with appropriately compatible devices can be provided via an Ethernet port 152, a USB (Universal Serial Bus) port 154, an IEEE 1394 (Firewire or I-Link) port 156, S-video port 158, or infrared port 160. These interfaces may be utilized to interconnect the STB 22 with any of a variety of devices such as storage devices, audio/visual devices 24, gaming devices (not shown), and Internet Appliances 28.

I/O interfaces 146 can include a modem port 162 to facilitate high speed or alternative access to the Internet or other data communication functions. In one preferred embodiment, modem port 162 includes a DOCSIS (Data Over Cable System Interface Specification) cable modem. This modem facilitates high speed network access over a cable system when port 162 is appropriately coupled to a transmission medium 20 embodied as a coaxial cable. A PS/2 or other keyboard/mouse/joystick coupled to port 164 may be used to enable data entry into the STB 22. STB 22 also may include a basic video output port 166 for direct connection to a television set such as 24. In one embodiment, Video output port 166 can provide composite video formatted as National Television System Committee (“NTSC”) video. In some embodiments, the video output port 166 may be coupled directly to the graphics processor 136 or the demultiplexer/descrambler 110 rather than passing through the system bus 130 as illustrated in the exemplary block diagram. S-Video signals at output port 158 can be similarly provided without passing through the system bus 130 if desired in other embodiments.

The infrared port 160 may be embodied as an infrared receiver 34 as illustrated in FIG. 1. The infrared port 160 may receive commands from an infrared remote control 36, infrared keyboard or other infrared control device. Although not explicitly shown, front panel controls may be used in some embodiments to directly control the operation of the STB 22 through a front panel control interface coupled to the I/O interfaces 146. Selected interfaces such as those described above and others can be provided in STB 22 in various combinations as required or desired.

STB 22 may also include a disc drive interface 170 and disc drive mass storage 172 for storage of content and data as well as providing storage of programs (software code) operating on CPU 132. STB 22 may also include other storage mediums such as a floppy disc drive, CD ROM drive, CD R/W drive, DVD drive, and others. CPU 132 is coupled through the system bus 130 to the memory 176. Memory 176 may include any suitable memory technology including Random Access Memory (RAM), Read Only Memory (ROM), Flash memory, Electrically Erasable Programmable Read Only Memory (EEPROM), and others.

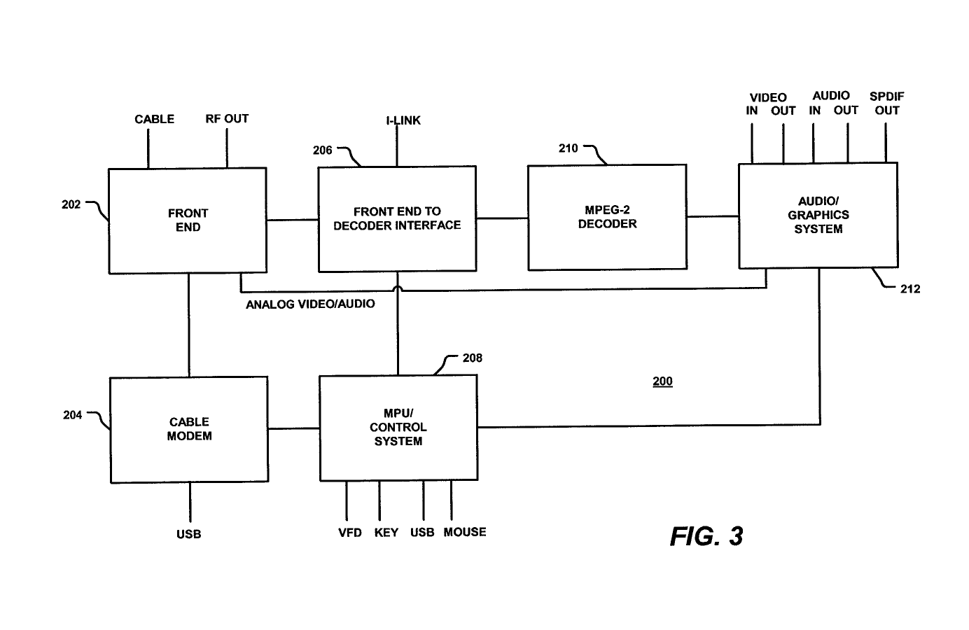

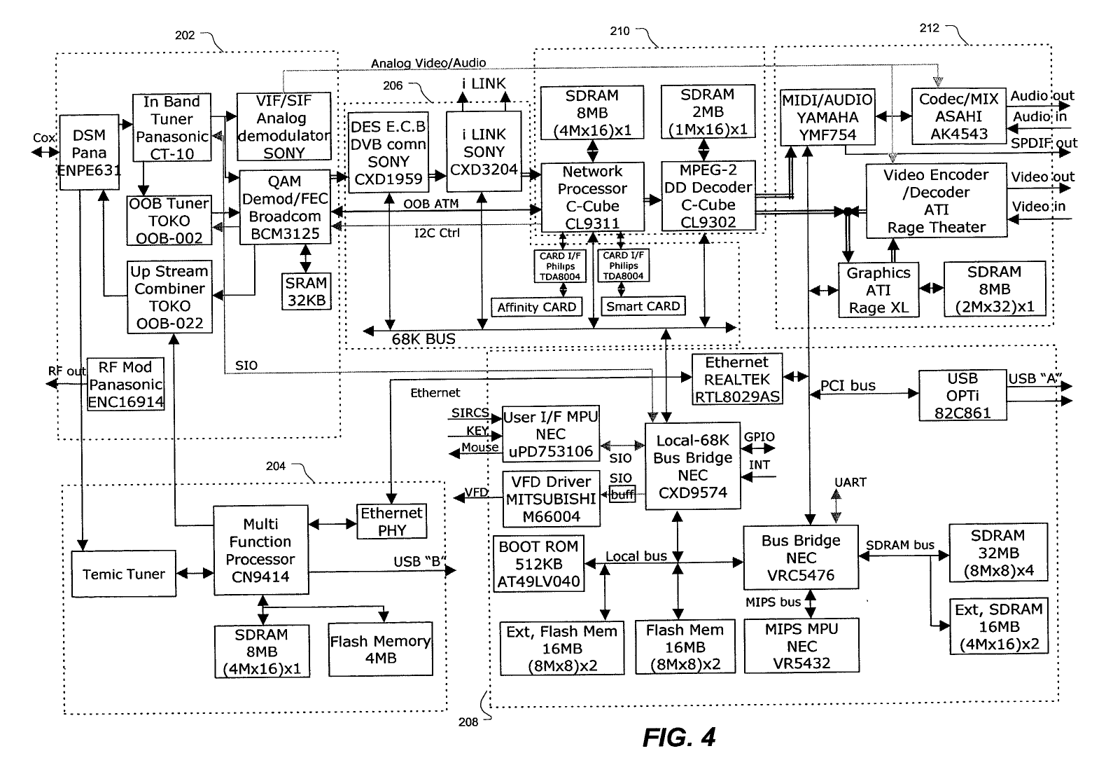

FIG. 3 is a basic block diagram of the media generation system in the form of an exemplary STB 200 capable of use with the present invention. A detailed block diagram of the STB 200 is shown in FIG. 4. STB 200 is described in detail in provisional Patent Application No. 60/197,233, filed Apr. 14, 2000, Attorney Docket No. 50P3877, entitled “Cable Modem Set Top Box” which is incorporated by reference herein for its teachings on the STB 200. Accordingly, the STB 200 is only briefly described with reference to FIGS. 3 and 4. The STB 200 includes a front end 202, cable modem 204, front end to decoder interface 206, MPU/control system 208, MPEG-2 Decoder 210, and Audio/Graphics System 212. The front end 202 may be coupled to a cable head end 10 via a cable 20 and cable network 11 as shown in FIG. 6. The front end 202 could be modified to communicate with alternative digital or analog content providers. The front end to decoder interface 206 links the front end 202, MPU/control system 208, and MPEG-2 decoder 210. The interface 206 includes card readers and an iLink™ interface. The MPEG-2 decoder 210 receives MPEG-2 content from the front end 202 (via the interface 206), and decodes the MPEG-2 content into frames for processing by the Audio/graphics system 212. The microprocessor unit (“MPU”)/control system 208 controls the primary operation of the STB 200. The system 208 includes a MPU that supports layers for drivers up to application program interfaces (“APIs”) that control the interaction of the components of the STB 200.

The system 208 may receive control data and software code update data from the front end 202 (via the interface 206) and send control data to the front end (and ultimately a content provider or media signal generator) via the cable modem 204 and front end 202. The cable modem 204 is coupled to the front end 202 and MPU/control system 208 and can retrieve and place digital data packets on the cable system (in this embodiment). The audio/graphics system 212 can receive video and audio content information from the front end (for analog video/audio), the MPEG-2 decoder (digital audio and video), and the MPU/control system 208.

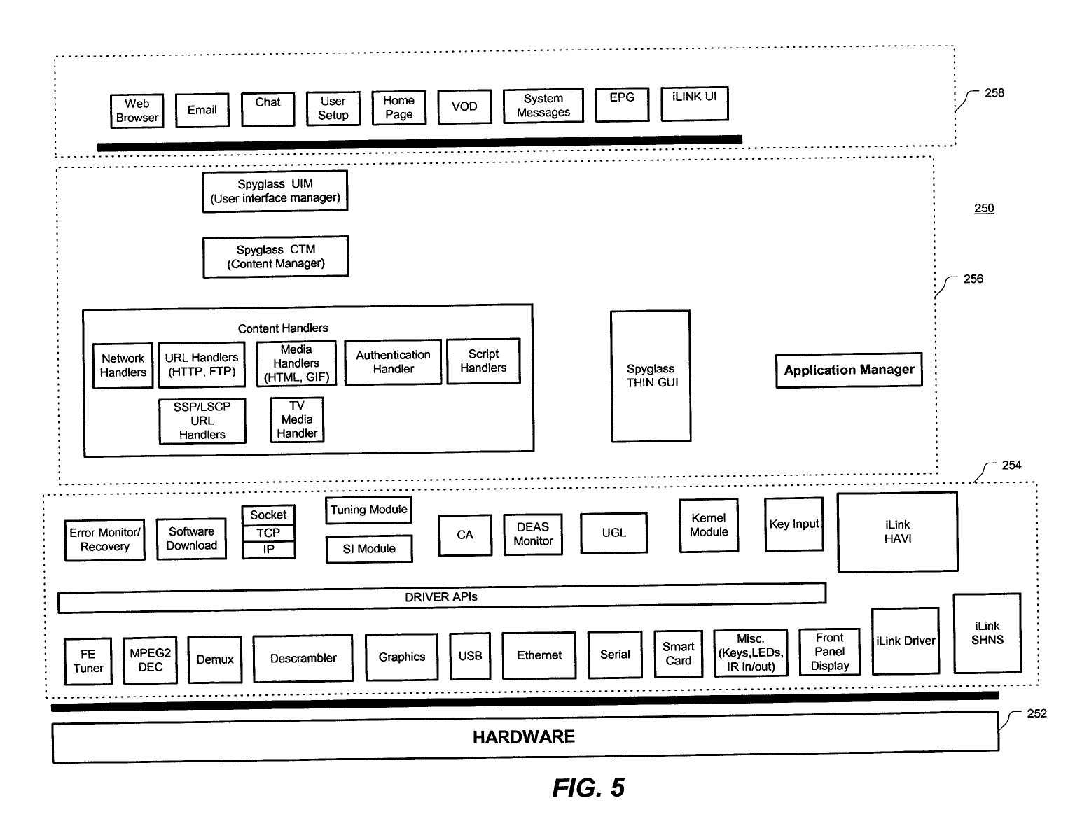

A block diagram of the software architecture 250 for the STB 200 is shown in FIG. 5. The architecture 250 depicts the hardware layer 252, hardware layer interface/driver layer 254, middleware layer 256, and local content/application layer 258. During normal operation of the STB 200, the driver APIs are loaded in the memory of the control system 208. The driver APIs enable communication of events between the MPU and the hardware modules of the STB 200. As shown in FIG. 5, the hardware modules include the Front End Tuner, MPEG-2 Decoder, Demultiplexer, Descrambler, Graphics, Ethernet, Serial port, Smart Card, miscellaneous hardware including keyboard, light-emitting-diodes, infrared, and front panel display.

The middleware layer 256 includes a group of content handlers, spyglass content manager, spyglass user interface manager, spyglass thin graphical user interface (“GUI”), and application manager. The middleware layer 256 enables the handlers and managers to run on multiple platforms with little regard for the actual operating system in place. At the top layer is the application layer where user applications reside (e.g. web browser, email, Chat, user setup, home page of STB, Video On Demand (VOD), EPG, and iLink user interface).

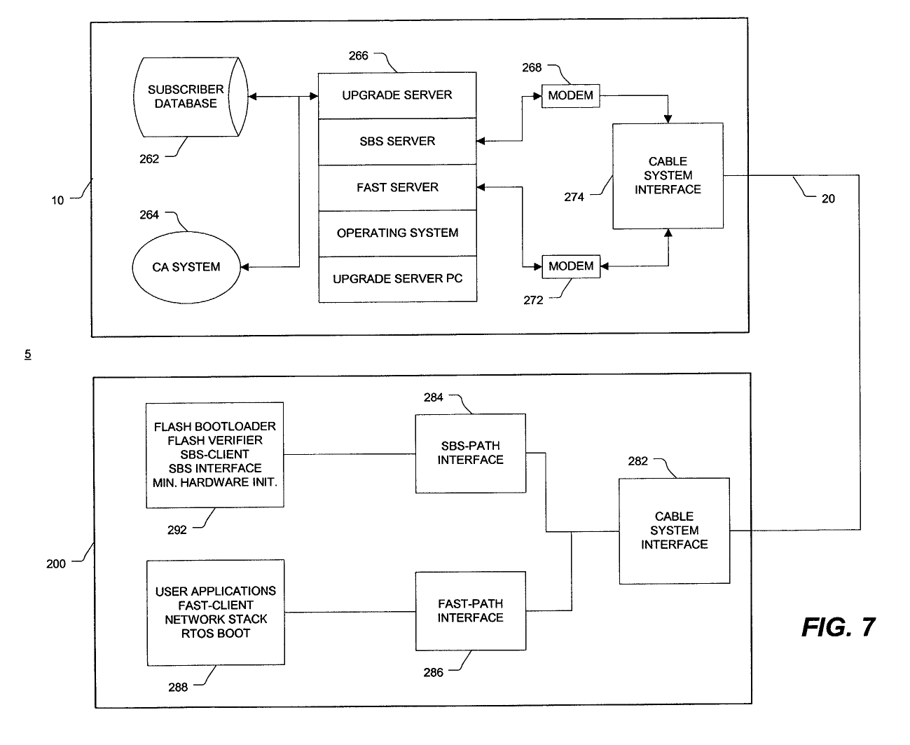

FIG. 7 is a block diagram of the cable architecture 5 detailing a data-downloading embodiment. As shown, the cable head end 10 includes a subscriber database 262, Cable (CA) system 264, upgrade server PC 266, a slow but sure (“SBS”) modem 268, a Fast-Path modem 272, and cable system interface 274. The upgrade server PC 266 includes several application programs including the upgrade client/server, SBS server, Fast server and Operating System (“OS”). The subscriber database 262 and the CA system 264 are linked to the upgrade server PC 266 and provide information about the set top box network. The SBS server application running on the PC 266 interfaces with the SBS modem 268. The Fast Server application running on the PC 266 interfaces with the Fast-Path modem 272. The cable system interface 274 directs signals between the modems 268 and 272 and the cable network 11 via the cable 20.

The exemplary set top box 200 includes a corresponding cable system interface 282, an SBS-path interface 284, a fast-path interface 286, a non-erasable code section of memory 292, and an erasable code section of memory 288. The cable system interface 282 directs signals between the SBS-path interface 284, the fast-path interface 286, and the cable network 11 via the cable 20. The non-erasable code section of memory 292 is used to store the Flash bootloader, Flash verifier, SBS-client, SBS interface software, minimal hardware initialization software. The erasable code section of memory 288 is used to store the User applications, Fast-client and interface software, Network stack, and real time operating system (“RTOS”) boot program.

In this embodiment there are three communications channels between the cable head end 10 and the STB 200 that the Upgrade Client/Server system 266 can use to transfer data and receive request/acknowledge messages including the cable modem interface, the out of band (“OOB”) channel, and the in band (“IB”) data channel. The cable modem interface is implemented in a STB 200 by several communications devices. The Out Of Band channel is a two-way medium data rate channel. A separate processor also controls the OOB channel. The In Band Data channel is a one-way stream of data contained within the MPEG stream. The base STB hardware is capable of filtering the data and passing it to the STB main processor via the bus.

The invention selects a fast-path channel and a slow but sure (SBS) channel for communicating between the cable head end 10 and STBs 200. When downloading program code to a system to be stored in non-erasable section of memory 292, in particular flashing memory with program code it is critical that the data transmission does not include losses or errors. For these types of transmissions, the invention uses the SBS channel. For updating code that is stored in erasable section of memory 288, the present invention uses the fast-path channel. This enables bandwidth efficiency while ensuring that critical transmissions are not corrupted.

In one embodiment, the cable modem channel provides the best performance and ease of use and is thus selected for the fast-path channel. The cable modem operates at a very high level within the software architecture of the head end and the STB. Accordingly, the update server software can take advantage of the Operating System libraries and network routines to provide an upgrade scheme with minimal effort. In particular, FTP, TFTP or a form of IP Broadcasting/Multicasting in the case could perform the upgrade process where parallel upgrades are desirable.

The use of the cable modem interface as the fast-path channel path requires that the STB Main Processor FLASH contain code and that code must be valid, the STB Main Processor RTOS to be fully booted, the STB Main Processor Network stack is operational, the Cable Modem Processor FLASH contains code and that code is valid, the Cable Modem Processor OS is fully booted, the Cable Modem Processor Network stack is operational, the current versions of STB code are compatible with the code in the cable head end 10. Accordingly, when any of these codes either do not exist, are incompatible, or are corrupt, then the cable modem interface cannot be used to upgrade the STB to a usable version. During normal operation of the STB, it is expected that all sub-systems and elements of the STB are operating correctly so the cable modem interface may used as the fast path channel and the fast-path channel is operative.

In another embodiment, the OOB channel may be used for the fast-path channel. The OOB Channel is a medium data rate channel. Additionally, the OOB channel is Ethernet based, Bi-directional, includes IP Multicast support, exists on all boxes (whereas the Cable Modem interface may not), the CA System interfaces directly with the OOB Channel, and is secure. The limitations of the OOB channel as the fast-path channel include are that the relatively low bandwidth of this channel must be shared with many other services, the hardware, the interface to the SBS Main Processor is bus type not the simple Ethernet type (requiring extra driver support). Further in order for the OOB channel to operate the SBS Main Processor FLASH must contain code and that code must be valid, the SBS Main Processor RTOS must be fully booted, the STB Main Processor Network stack must be operational, the OOB Processor FLASH must contain code and that code must be valid, the OOB Processor OS must be fully booted, the OOB Modem Processor Network stack must be operational, and the current versions of SBS code must be compatible with code in the cable head-end 10.

As noted ideally, the Slow But Sure (“SBS”) upgrade path/channel provides a way for the cable head end 10 to pass SBS software to the SBS with little or no RTOS and network support within the SBS itself required. Additionally, the code required to implement the SBS-PATH Client should reside in a non-erasable section 292 of the SBS memory. Because this code is nonerasable it is desirable to keep it as simple as possible. The SBS channel client should also require only minimal hardware initialization, i.e., enough to allow the client to talk to the SBS-PATH Interface Hardware and operate out of RAM and program FLASH.

Accordingly, in one embodiment, the In Band Channel is the SBS-PATH. The In Band Channel consists of data formatted into MPEG Transport packets or sections carried in the transport stream that contains the Video, Audio and other data streams. The interface between the STB Main Processor and the In Band Channel is via hardware Transport Stream Demux, which has the capability to filter certain packets or sections and pass those on to the Main Processor via the Main Processors bus. Thus, the in Band Channel—SBS-PATH Client of the STB would initialize the Transport Stream Interface Hardware (including Tuner, Demod Demux), parse information out of the Transport Stream to determine where the In Band Channel exists, program the Transport Stream Demux hardware to filter through that channel, extract the sections of the image from the In Band Data, perform error-detection and correct the sections as required, re-assemble the sections into the final image, verify the final Image, program the flash, set a flag in flash so that when the new code starts up it will send an acknowledge to the Upgrade Server of the cable head end 10, maintain some upgrade/error statistics in EEPROM, and reset the STB. All of these operations require no real RTOS intervention and there is no need for the network stack to be started.

In this embodiment, the SBS-path channel is chosen to send upgrades for Production Line Boxes to perform the first load of shipping/test code into a blank FLASH, for a STB having a corrupted STB Main Processor FLASH code, making the FAST-PATH channel unusable, for a STB having a corrupted STB Cable Modem/OOB Processor FLASH code, making the FAST-PATH channel unusable. The SBS-path channel is also chosen when there is network incompatibility between the cable head end 10 and a STB 200, e.g., when a change in one of the underlying network protocols, makes the FAST-PATH channel unusable or when the STB version does not support a cable modem.

It is noted, however, in the OOB channel could potentially be used for the SBS-PATH in some embodiment. In this case, the upgrade process could be tried to the CA System. The OOB, however, still requires IP protocol communications between the cable head end 10 and the STB 200 and additional drivers.

Thus in this embodiment, there are two independent upgrade channels, one that is fast and efficient (FAST-PATH channel) and another that is slow but guaranteed (SBS-PATH channel) so thousands of these boxes do not become unusable due to some error in the Upgrade process. The SBS-path channel (safe upgrade scheme), may also enable a cable head end operator to release new code, solve customer service problems and add features to the STB without fear of STB corruption. Additionally, during STB production, a STB may be loaded with code automatically as they come off the line using the SBS-path. Then, the production test line may switch between special test versions of the software and release versions, simply and quickly. It is noted that the OS, Device Drivers, Network Stack and Application software used in the STB may undergo changes throughout the life of the box, therefore it is imperative that the SBS upgrade path be as independent as possible of changes in the code. The fast-path (efficient) upgrade path can take advantage of all the features the hardware and Operating System allowing for a robust and easy implementation.

As noted, the In Band Channel consists of data formatted into MPEG Transport packets or sections carried in the transport stream that contains the Video, Audio and other data streams. Accordingly, when the IB channel is selected as the SBS upgrade channel, the upgrade data must be transformed in MPEG transport packets prior to transmission. An embodiment of packing update files into a packed image is described in the co-pending and commonly assigned provisional Patent Application No. 60/197,312, filed Apr. 14, 2000, Attorney Docket No. 50P3987, and entitled “Method for Downloading Code”, which is hereby incorporated by reference for its teachings on the same.

As noted millions of STBs may exist on a cable network where the STBs have different software versions and require software upgrades on a continual basis based on the release of new features, applications, or patches to correct existing code. In order to efficiently transmit packed images representing potentially several different software upgrades (based on the present software configuration of each STB), one embodiment employs a data carouselling technique for SBS-path upgrades. This technique helps overcome the slow aspect of the SBS-path upgrade process. The SBS-path (IB upgrade) data will be encapsulated by the module delivery protocol, described in the co-pending and commonly assigned provisional Patent Application No. 60/197,312, filed Apr. 14, 2000, Attorney Docket No. 50P3987, and entitled “Method for Downloading Code”. The protocol-encapsulated data shall be carried in the MPEG-2 transport as private data within transport stream packets as defined by ISO/IEC 13818-1, Annex H, H.0 Private Data Transport Stream packet Table 2-2. This protocol is also compatible with the Digital Video Broadcast (“DVB”) standard for Data Piping defined in EN301 192 V1.1.1 (1997-12) DVB Specification for Data Broadcasting, Data Piping.

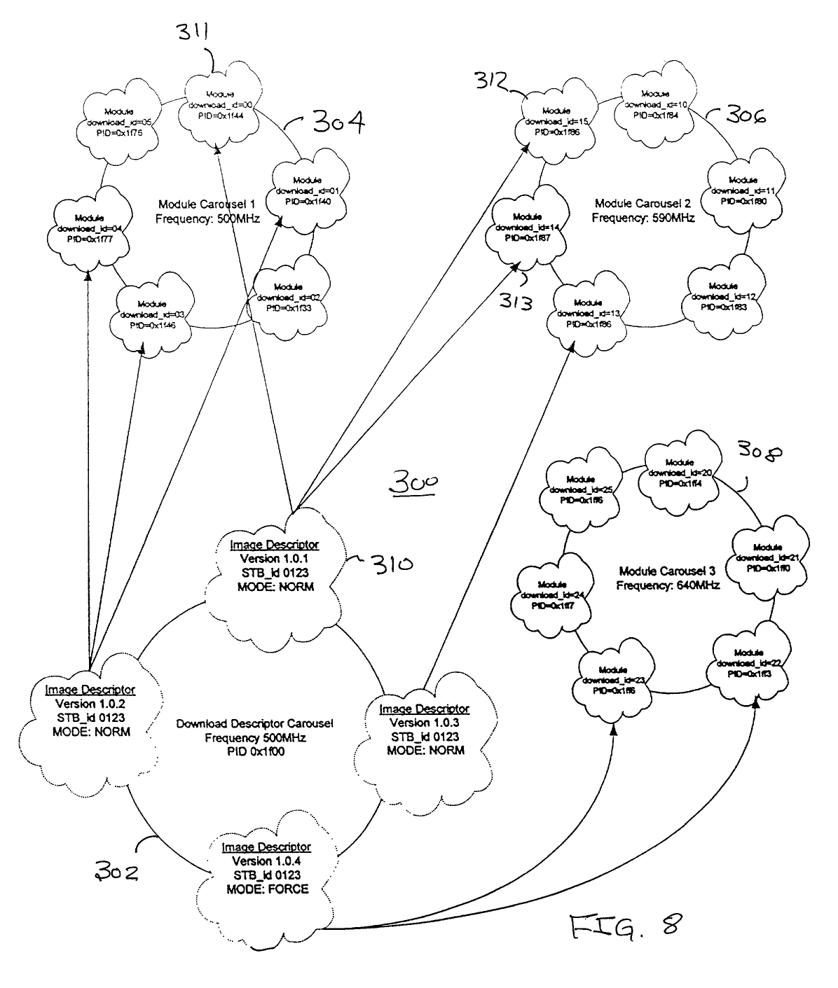

FIG. 8 is illustration of one embodiment of a data carouselling technique 300. In this embodiment, all information describing the images available in data carousels 304, 306, and 308 is contained in a Download Descriptor Message that is placed in a separate Download Descriptor carousel 302. Accordingly, a STB 200 first references the Download Descriptor Carousel 302 to determine what images are available for the STB and the data carousel locations of those images. Note that a download descriptor message may be linked to more than one STB 200. In particular, the message may be linked to all STB 200 having the software configuration. The descriptor message then indicates that software modules to be downloaded, decoded, and used to update code of the STB 200 is located in one or more data carousels. For example, Image descriptor 310 indicates that a module 311 is located in module carousel 1 (304), and two additional modules 312 and 313 are located in module carousel 2 (306).

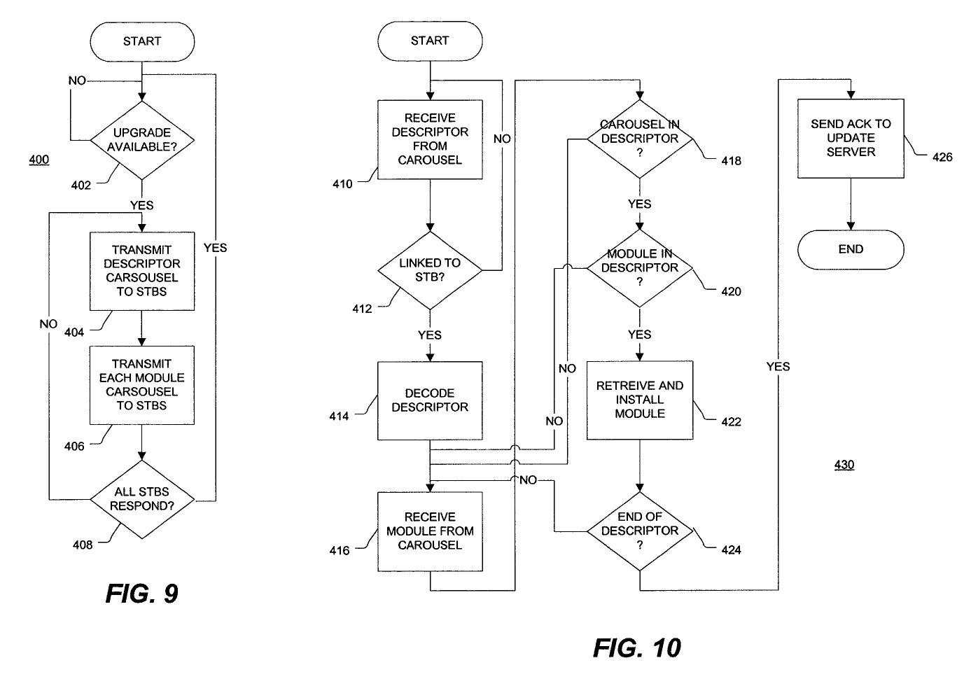

FIG. 9 is a flowchart of the upgrade server process 400 of transmitting an upgrade to a group of STBs using data carousels in one embodiment. FIG. 10 is a flowchart of a STB process 430 of retrieving an upgrade within the STB using data carousels in the embodiment. In operation, when an upgrade is available (step 402), the upgrade server of the cable head end 10 transmits the download descriptor carousel throughout the cable network 11 to STBs 200 (step 404). Each STB 200 looks for descriptors linked to the STB (steps 410 and 412). If linked descriptor is located in the descriptor carousel, it is downloaded and decoded to determine which module carousel will contain module upgrades for the STB (step 414) (for the particular STB model or software version). When the upgrade server of the cable head end 10 starts transmitting modules of a module carousel (step 406) (304, 306, or 308), the STB evaluates the module carousel (steps 416, 418, and 420). When the module carousel matches one in the descriptor file, the STB waits for the corresponding modules of the module carousel, downloads, and installs them (steps 420 and 422). The STB 200 may generate an acknowledgment message when it successfully completes installation of all the modules associated with a descriptor file (steps 424 and 426).

The upgrade server of the cable head end 10 may continue this process for all module carousels associated with the download descriptor carousel (step 406). Then, the cable head end 10 (via the upgrade server) may retransmit the download descriptor carousel and modules until all the appropriate STB have acknowledged successful installation of the associated modules (upgrade code) (steps 404, 406, and 408). In other embodiments, the upgrade server may not wait determine whether all STBs linked to the upgrade have acknowledged successful receipt and installation of the upgrade via the modules.

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware (e.g., a software language other than Java, such as C++ or others may be used to implement the invention). As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

What is claimed is:

1. A method of downloading code to at least one remote unit on a network having a plurality of remote units wherein there are a plurality of data paths for transmitting code to each remote unit, comprising the steps of:
a) selecting one of the plurality of data paths based on the code to be transmitted; and
b) transmitting the code to the at least one remote unit on the selected data path.

2. The method of downloading code to at least one remote unit of claim 1, wherein the units are set top boxes.

3. The method of downloading code to at least one remote unit of claim 1, wherein the code is software code used to update the software running on the at least one unit.

4. The method of downloading code to at least one remote unit of claim 3, wherein at least one path of the plurality of paths has a different data rate loss than the other paths of the plurality of data paths.

5. The method of downloading code to at least one remote unit of claim 4, wherein step a) comprises selecting one of the plurality of data paths based on the code to be transmitted and the data rate loss of the path.

6. The method of downloading code to at least one remote unit of claim 4, wherein step a) comprises selecting one of the plurality of data paths having the lowest data rate loss.

7. The method of downloading code to at least one remote unit of claim 4, wherein step a) comprises selecting one of the plurality of data paths having the lowest data rate loss when the code represents critical software for the at least one unit.

8. The method of downloading code to at least one remote unit of claim 4, wherein step a) comprises selecting one of the plurality of data paths having the lowest data rate loss where the code represents critical software stored in non-erasable memory of the at least one unit.

9. The method of downloading code to at least one remote unit of claim 1, wherein step b) comprises transmitting the code to the plurality of remote units in a descriptor file that indicates the at least one remote unit is recipient of the code.

10. The method of downloading code to at least one remote unit of claim 8, wherein step b) comprises the steps of:
a) transmitting a descriptor file to the plurality of units that indicates at least one remote unit is to receive the code; and
b) transmitting the code to all remote units.

11. The method of downloading code to at least one remote unit of claim 1, wherein step b) comprises the steps of:
a) separating the code into a plurality of modules;
b) transmitting a descriptor file to the plurality of units that indicates at least one remote unit is to receive the code and the code is separated into a plurality of modules; and
c) transmitting the plurality of modules to the plurality of remote units.

12. The method of downloading code to at least one remote unit of claim 11, further comprising the steps of:
a) each remote unit receiving the descriptor file; and
b) each remote unit retrieving the modules identified by the descriptor file when the descriptor file indicates the remote unit is to receive the modules.

13. The method of downloading code to at least one remote unit of claim 11, further comprising the steps of:
a) each remote unit receiving the descriptor file; and
b) each remote unit retrieving the modules identified by the descriptor file and assembling the modules into the code when the descriptor file indicates the remote unit is to receive the modules.

14. The method of downloading code to at least one remote unit of claim 11, further comprising the steps of:
a) each remote unit receiving the descriptor file; and
b) each remote unit retrieving the modules identified by the descriptor file, assembling the modules into the code, and installing the code when the descriptor file indicates the remote unit is to receive the modules.

15. An article of manufacture for use in downloading code to at least one remote unit on a network having a plurality of remote units wherein there are a plurality of data paths for transmitting code to each remote unit, the article of manufacture comprising computer readable storage media including program logic embedded therein that causes control circuitry to perform the steps of:
a) selecting one of the plurality of data paths based on the code to be transmitted; and
b) transmitting the code to the at least one remote unit on the selected data path.

16. The article of manufacture for use in downloading code to at least one remote unit of claim 15, wherein the units are set top boxes.

17. The article of manufacture for use in downloading code to at least one remote unit of claim 15, wherein the code is software code used to update the software running on the at least one unit.

18. The article of manufacture for use in downloading code to at least one remote unit of claim 17, wherein at least one path of the plurality of paths has a different data rate loss than the other paths of the plurality of data paths.

19. The article of manufacture for use in downloading code to at least one remote unit of claim 18, wherein step a) comprises selecting one of the plurality of data paths based on the code to be transmitted and the data rate loss of the path.

20. The article of manufacture for use in downloading code to at least one remote unit of claim 18, wherein step a) comprises selecting one of the plurality of data paths having the lowest data rate loss.

21. The article of manufacture for use in downloading code to at least one remote unit of claim 18, wherein step a) comprises selecting one of the plurality of data paths having the lowest data rate loss when the code represents critical software for the at least one unit.

22. The article of manufacture for use in downloading code to at least one remote unit of claim 18, wherein step a) comprises selecting one of the plurality of data paths having the lowest data rate loss where the code represents critical software stored in non-erasable memory of the at least one unit.

23. The article of manufacture for use in downloading code to at least one remote unit of claim 15, wherein step b) comprises transmitting the code to the plurality of remote units in a descriptor file that indicates the at least one remote unit is recipient of the code.

24. The article of manufacture for use in downloading code to at least one remote unit of claim 22, wherein step b) comprises the steps of:
a) transmitting a descriptor file to the plurality of units that indicates at least one remote unit is to receive the code; and
b) transmitting the code to all remote units.

25. The article of manufacture for use in downloading code to at least one remote unit of claim 15, wherein step b) comprises the steps of:
a) separating the code into a plurality of modules;
b) transmitting a descriptor file to the plurality of units that indicates at least one remote unit is to receive the code and the code is separated into a plurality of modules; and
c) transmitting the plurality of modules to the plurality of remote units.

26. The article of manufacture for use in downloading code to at least one remote unit of claim 25, further comprising the steps of:
a) each remote unit receiving the descriptor file; and
b) each remote unit retrieving the modules identified by the descriptor file when the descriptor file indicates the remote unit is to receive the modules.

27. The article of manufacture for use in downloading code to at least one remote unit of claim 25, further comprising the steps of:
a) each remote unit receiving the descriptor file; and
b) each remote unit retrieving the modules identified by the descriptor file and assembling the modules into the code when the descriptor file indicates the remote unit is to receive the modules.

28. The article of manufacture for use in downloading code to at least one remote unit of claim 25, further comprising the steps of:
a) each remote unit receiving the descriptor file; and
b) each remote unit retrieving the modules identified by the descriptor file, assembling the modules into the code, and installing the code when the descriptor file indicates the remote unit is to receive the modules.

29. An apparatus for downloading code to at least one remote unit on a network having a plurality of remote units wherein there are a plurality of data paths for transmitting code to each remote unit, comprising:
a) means for selecting one of the plurality of data paths based on the code to be transmitted; and
b) means for transmitting the code to the at least one remote unit on the selected data path.

30. The apparatus for downloading code to at least one remote unit of claim 29, wherein the units are set top boxes.

31. The apparatus for downloading code to at least one remote unit of claim 29, wherein the code is software code used to update the software running on the at least one unit.

32. The apparatus for downloading code to at least one remote unit of claim 31, wherein at least one path of the plurality of paths has a different data rate loss than the other paths of the plurality of data paths.

33. The apparatus for downloading code to at least one remote unit of claim 32, wherein the means for selecting comprises means for selecting one of the plurality of data paths based on the code to be transmitted and the data rate loss of the path.

34. The apparatus for downloading code to at least one remote unit of claim 32, wherein the means for selecting comprises means for selecting one of the plurality of data paths having the lowest data rate loss.

35. The apparatus for downloading code to at least one remote unit of claim 32, wherein the means for selecting comprises means for selecting one of the plurality of data paths having the lowest data rate loss when the code represents critical software for the at least one unit.

36. The apparatus for downloading code to at least one remote unit of claim 32, wherein the means for selecting comprises means for selecting one of the plurality of data paths having the lowest data rate loss where the code represents critical software stored in non-erasable memory of the at least one unit.

37. The apparatus for downloading code to at least one remote unit of claim 29, wherein the means for transmitting comprises means for transmitting the code to the plurality of remote units in a descriptor file that indicates the at least one remote unit is recipient of the code.

38. The apparatus for downloading code to at least one remote unit of claim 36, wherein the means for transmitting comprises:
a) means for transmitting a descriptor file to the plurality of units that indicates at least one remote unit is to receive the code; and
b) means for transmitting the code to all remote units.

39. The apparatus for downloading code to at least one remote unit of claim 29, wherein the means for transmitting comprises:
a) means for separating the code into a plurality of modules;
b) means for transmitting a descriptor file to the plurality of units that indicates at least one remote unit is to receive the code and the code is separated into a plurality of modules; and
c) means for transmitting the plurality of modules to the plurality of remote units.
